(19) United States
(12) Patent Application Publication
(10) Pub. No.: US 2011/0266199 A1
(43) Pub. Date: Nov. 3, 2011

(54) DEVICE FOR SELECTING AND SEPARATING OBJECTS

(76) Inventors: Douglas Barnett, Olathe, KS (US); Ryan Foltz, Fairway, KS (US); Robert Jones, Shawnee, KS (US); Frank J. Criscione, II, Kansas City, MO (US); Oliver Hahn, Parkville, MO (US)

(21) Appl. No.: 12/914,860

(22) Filed: Oct. 28, 2010

Related U.S. Application Data
(60) Provisional application No. 61/255,840, filed on Oct. 28, 2009.

(51) Int. Cl. B07C 5/00; B07C 5/16; B07C 5/342; B07C 5/04

(52) U.S. Cl. 209/592; 209/552

(57) ABSTRACT

The present invention provides a device for sorting items according to at least one predetermined criterion. The device includes at least one conveyor for transporting an item along at least a portion of the device, a measuring until positioned in proximity to the conveyor for receiving the items from the conveyor, and at least one separation gate along a length of the at least conveyor that can be selectively actuated based on at least one predetermined criteria measured by the measuring unit.

### RELATED APPLICATIONS

The present application claims priority of U.S. Provisional Patent Application No. 61/255,840, entitled “Device for Selecting and Separating Objects,” filed on Oct. 28, 2009.

### BACKGROUND OF THE INVENTION

1. Field of the Invention

The present invention relates generally to a device for selecting and separating objects, and more specifically to a device for selecting and separating food items.

2. Description of the Prior Art

In process, industrial, and other settings it is often necessary to sort items based on certain predetermined characteristics. Such characteristics may include size, conformity to a standard, color, or any other characteristic that can be readily determined by one sorting the items. Such work is often done manually, with workers observing items as they pass along a line or conveyor system, making judgments about those items, and then sorting the items or otherwise directing them to a desired location.

In the food processing industry, meat items must often be sorted based on size, weight, or other characteristics. Much or all of this sorting process maybe performed manually, though portions of the process may be automated. For example, a conveyor system may be used to direct the meat items to a scale for weighing, after which manual sorting may be performed. Such systems generally occupy a lot of floor space as the meat items typically pass through the system lengthwise.

What is needed is an automated system for measuring or otherwise identifying certain criteria of items, such as food items, and then automatically sorting the items based on those criteria, and which takes up as little floor space as possible.

### SUMMARY OF THE INVENTION

The present invention provides a device for sorting items according to at least one predetermined criterion. The device includes at least one conveyor for transporting an item along at least a portion of the device, a measuring unit positioned in proximity to the conveyor for receiving the items from the conveyor, and at least one separation gate along a length of the at least one conveyor that can be selectively actuated based on at least one predetermined criterion measured by the measuring unit.

One aspect of the present invention provides that the measuring unit is a scale.

Another aspect of the present invention provides that the measuring unit is an imaging device.

Another aspect of the present invention provides that the predetermined characteristic is size.

Another aspect of the present invention provides that the predetermined characteristic is weight.

### BRIEF DESCRIPTION OF THE DRAWING FIGURES

FIG. 1 is a side perspective view of a device constructed in accordance with the teachings of the present invention.

FIG. 2 is a closeup side perspective view of a portion of the device of FIG. 1.

FIG. 3 is a rear perspective view the device of FIG. 1.

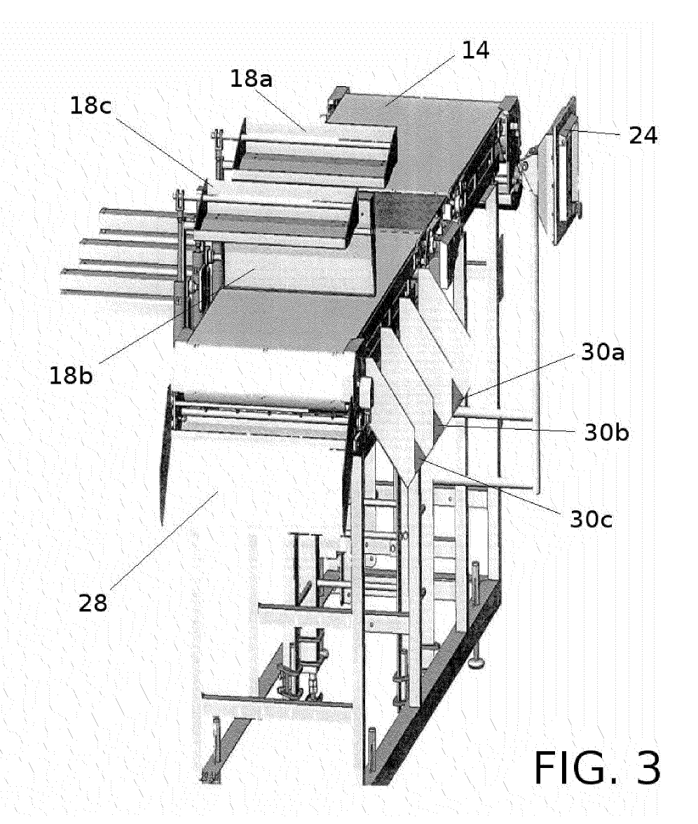

FIG. 4 is a closeup side perspective view of a portion of the device of FIG. 1.

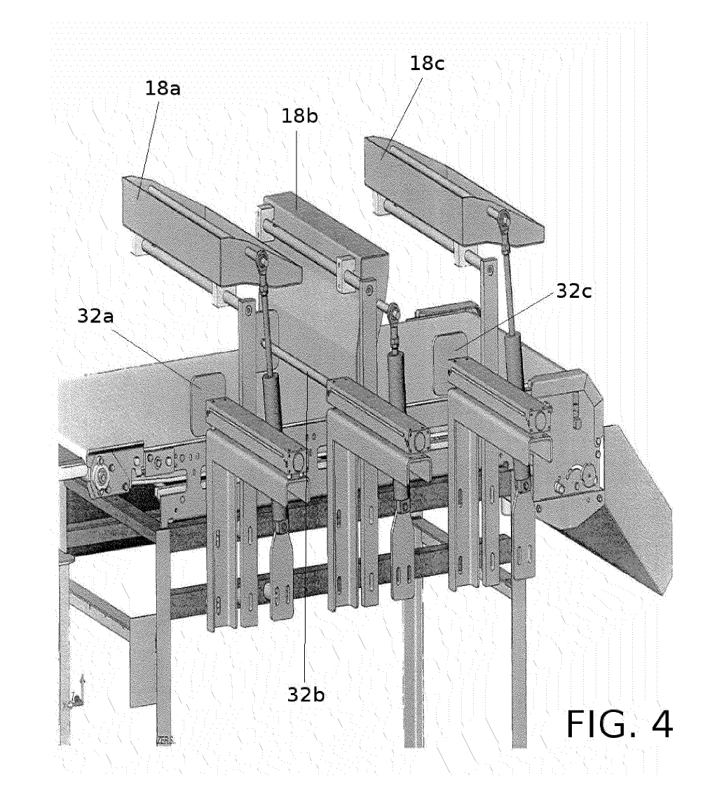

FIG. 5 is a closeup perspective view of a separating gate and push rod of the device of FIG. 1.

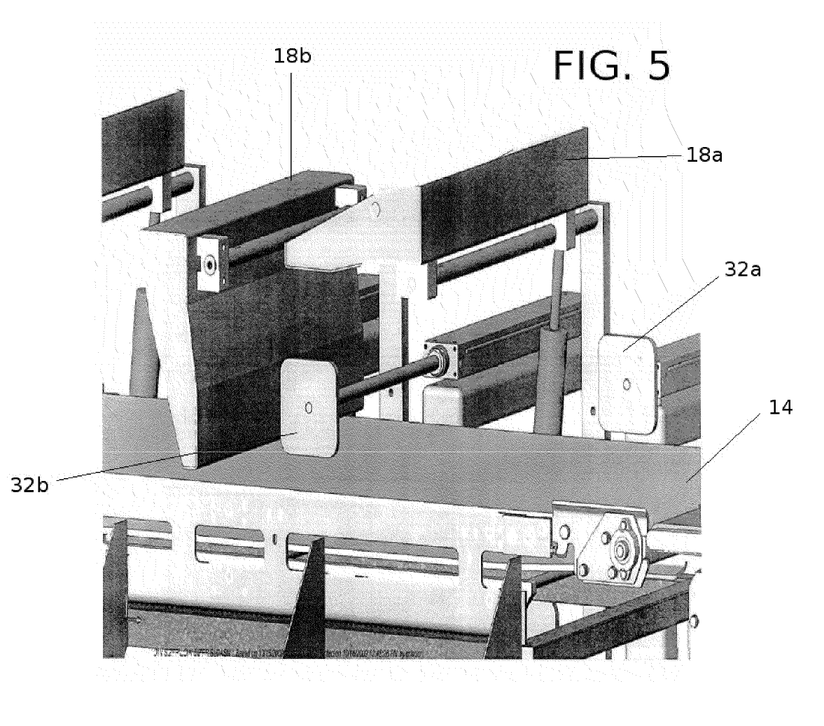

FIG. 6 is a rear perspective view of the device of FIG. 1.

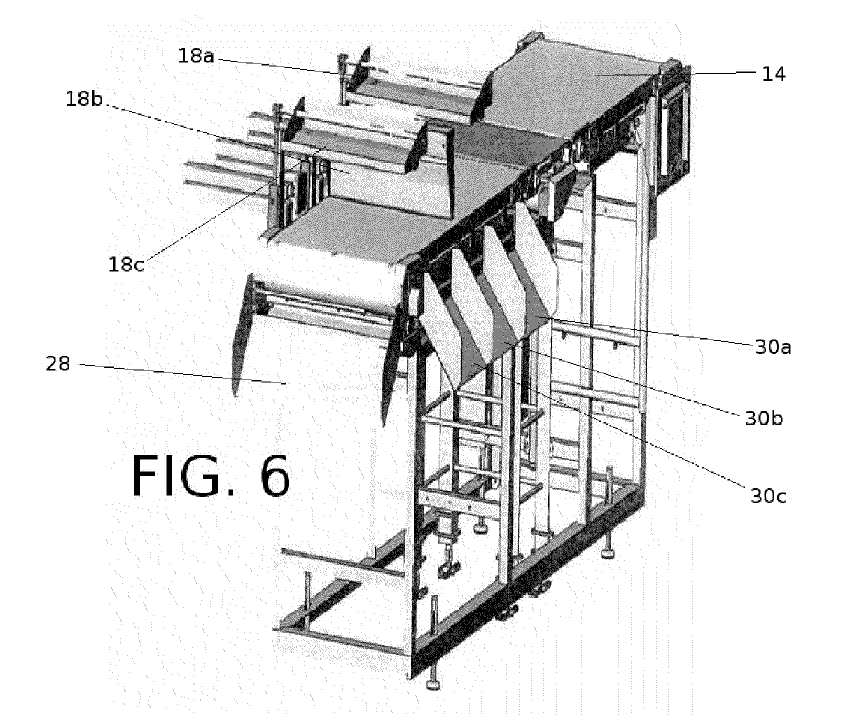

FIG. 7 is a front/side elevational view of the device of FIG. 1.

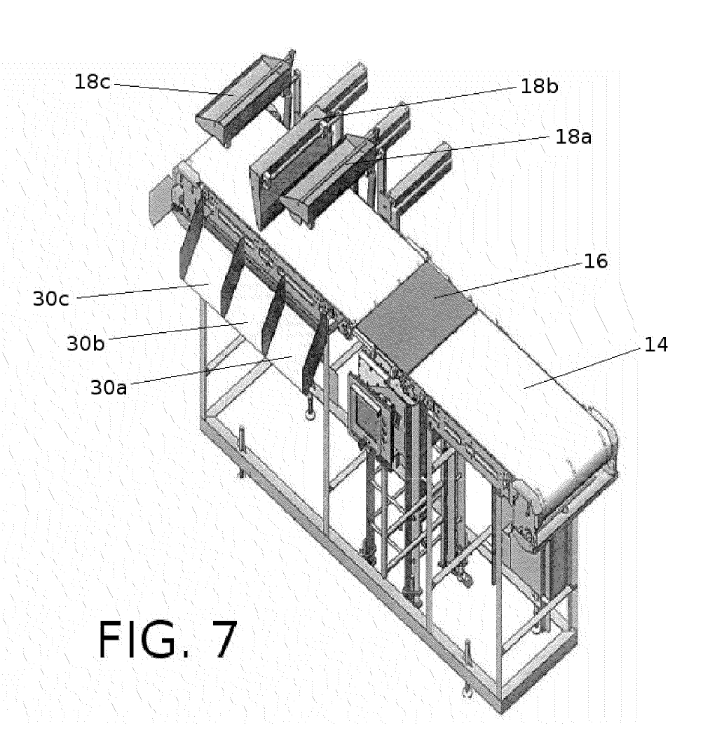

### DETAILED DESCRIPTION OF THE PREFERRED EMBODIMENTS

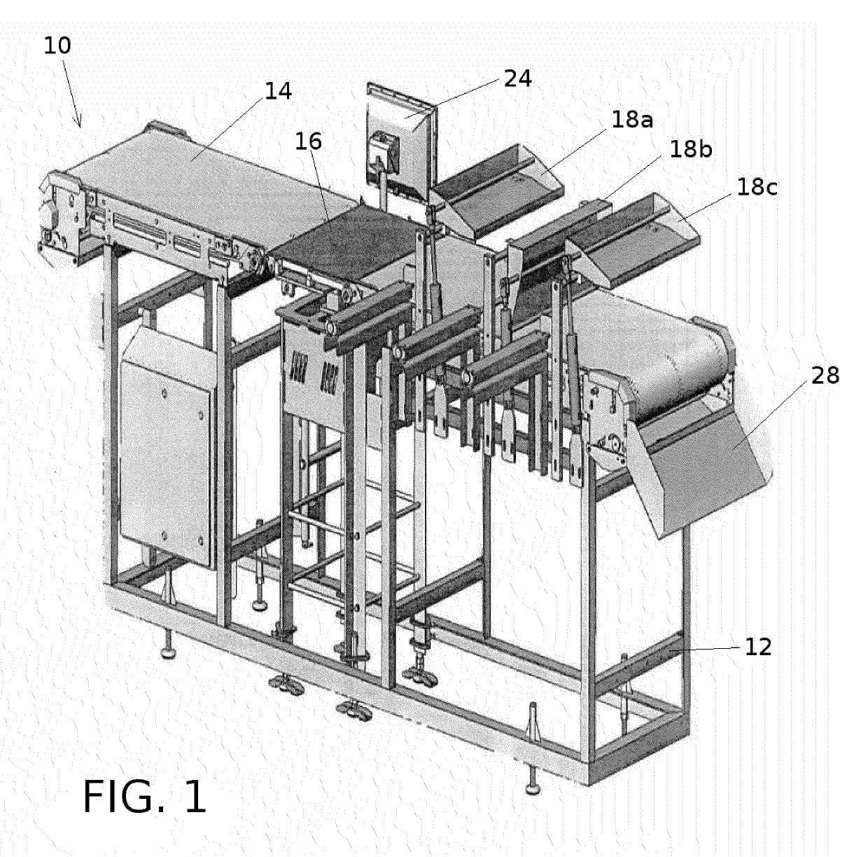

Turning now to the drawings, wherein like numerals indicate like parts, FIG. 1 depicts generally a device 10 constructed according to the principles of the present invention. Device 10 includes a frame 12, a conveyor 14, a scale 16, and separating gates 18a, 18b, and 18c, among other components that are identified and described below. While the device 10 shown in FIG. 1 is adapted for weighing items moving along conveyor 14 and then separating them accordingly, it is contemplated that such a device could employ any suitable criterion, or multiple criteria, for separating items moving along conveyor 14. Further, while the device 10 shown in FIG. 1 is adapted for use in selecting and separating food items, such as meats, it is contemplated that a device may be constructed according to the principles of the present invention for selecting and separating any suitable objects.

Frame 12 provides a rigid support for the other components of device 10, and may be constructed from any suitable material. Floor space in a factory setting is typically quite valuable, and thus one advantage of the present device 10 is the shortened length of frame 12, and therefore the entire device, as compared to devices currently used in the art. The configuration of the present invention allows food items such as, for example, loin cuts, to travel sideways along conveyor 14 rather than lengthways as typically found in existing devices. Conveyor 14 can be constructed from any suitable material, and it is contemplated that for devices 10 used in the food processing industry, regulations and other considerations for portions of device 10 that come into direct contact with food will be taken into account. Further for specialized food industries such as the organic food industry, other requirements may also come to bear on the selection of materials used to construct the various components of device 10 that contact food items. It is contemplated, however, that such materials are known to those of skill in the art and that it will be apparent, upon review of this disclosure, that such materials may be utilized in the construction of the present device 10.

Objects such as food items may be fed onto conveyor 14 in any suitable way, whether placed on conveyor 14 manually or directed onto conveyor 14 by an automated mechanism. Once an item, such as a meat loin, is placed on conveyor 14 it is carried along conveyor 14 toward scale 16, where the item is weighed. The result of the weighing determines which of separating gates 18a, 18b, or 18c will be engaged. As shown in the figures separating gates 18a, 18b, and 18c each include a rod 26 attached thereto, the rod being attached also to a rotator 22. When an item is weighed on scale 16, one of separating gates 18a, 18b, and 18c is engaged, as determined by the weight of the item, and rotator 22 rotates that gate such that it is positioned to be lowered to conveyor 14 and stop the progress of the food item along conveyor 14. Once the gate has been rotated, an actuator 20 moves the gate into proper position along conveyor 14. The food or other item traveling along conveyor 14 impacts the appropriate gate at the point at which the gate meets conveyor 14 and the food or other item is stopped. Push rod 32a, 32b, or 32c then pushes the food or other item off of conveyor 14.

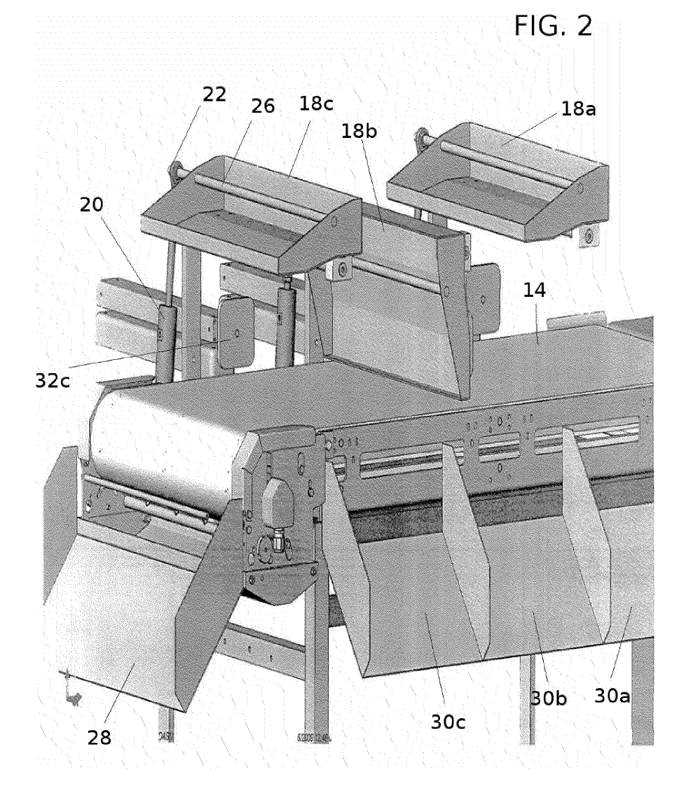

When the food item or other item contacts one of gates 18a, 18b, or 18c, and is subsequently pushed off of conveyor 14 by push rod 32a, 32b, or 32c, it travels along one of chutes 30a, 30b, and 30c to a receptacle (not shown) or other desired area adapted to receive the food or other item. Push rods 32a, 32b, and 32c, and chutes 30a, 30b, and 30c are shown clearly in FIG. 2. Thus, a food or other item stopped by separating gate 18a is pushed by push rod 32a and travels along chute 30a to the item's next destination. Likewise, if the food or other item is stopped by gate 18b, it is pushed by push rod 32b and travels along chute 30b, and if the food or other item is stopped by gate 18c it is pushed by push rod 32c and travels along chute 30c. Items sharing similar characteristics, in this case weight as determined by scale 16, are directed to the same gate, along the same chute, and ultimately to the same desired end point. In this way, items moving along conveyor 14 are sorted according to a predetermined characteristic.

It is contemplated that certain food or other items traveling along conveyor 14 may fail to trigger any of gates 18a, 18b, and 18c. This may occur, for example, when criteria set for engaging these gates is not met by the food or other item as measured by scale 16. In such instances, the food or other item moves to the end of conveyor 14 and travels along exit chute 28 to a desired receptacle or other desired location (not shown).

In the device 10 shown in the figures, operation of device 10 is controlled by a user via control panel 24. It is contemplated that control of device 10 may occur in any suitable manner, and that device 10 may be controlled at the site of device 10, as shown in the figures, or that device 10 may be controlled remotely. In instances wherein device 10 is controlled at the site of device 10 and control panel 24 is present, it is contemplated that a user may control any of the various features and variables of device 10. Such features and variables include, but are not limited to, the speed of conveyor 14 and the criteria used to determine which of gates 18a, 18b, and 18c will be engaged. Control panel 24 may be, for example, a touch screen associated with a computer system for controlling device 10.

While as shown and described above, device 10 includes a scale 16 for measuring food and other items moving along conveyor 14 for selection and separation, it is contemplated that criteria other than weight may be utilized for selection and separation of food and other items. For example, scale 16 may be replaced with an imaging device adapted to image a food or other item traveling along conveyor 14 and onto or over the imaging device. Once the food or other item is imaged, any of a variety of selection criteria based on the image may be used to determine which of gates 18a, 18b, and 18c is actuated, or whether the item is allowed to continue along conveyor 14 to exit chute 28. The criteria obtained via the imaging device and used in the selection and separation process may include, but are not limited to, shape, color, and size. With respect to food items, for example, the image obtained from and imaging device may be used, in part, to determine identity, freshness, or other characteristics of the food item that are capable of being determined visually. It is also contemplated that an image obtained as described above maybe compared electronically to a standard in order to determine whether or not the food or other item being imaged is desirable.

Having thus described the preferred embodiment of the invention, what is claimed as new and desired to be protected by Letters Patent includes the following:

1. A device for sorting items according to at least one predetermined criterion, the device comprising:
at least one conveyor for transporting an item along at least a portion of the device;
a measuring unit positioned in proximity to the conveyor for receiving the items from the conveyor; and
at least one separation gate along a width of the at least one conveyor and in communication with the measuring unit such that the gate can be selectively actuated based on at least one predetermined criterion measured by the measuring unit.

2. The device according to claim 1 wherein the measuring unit is a scale.

3. The device according to claim 1 wherein the measuring unit is an imaging device.

4. The device according to claim 1 wherein the at least one predetermined criterion is size.

5. The device according to claim 1 wherein the at least one predetermined criterion is weight.

6. The device according to claim 1 wherein the at least one conveyor is adapted to receive items having a length and width, the length of the item being greater than the width, and further wherein the item received on the at least one conveyor is oriented such that an axis extending along the length of said item is substantially perpendicular to the direction of movement of the at least one conveyor.

7. The device according to claim 1 wherein the at least one separation gate is in a first position away from the conveyor when not actuated and moves to a second position along a width of the at least one conveyor.

8. The device according to claim 7 wherein the at least one separation gate moves from the first position to the second position by a rotating action.

9. The device according to claim 1 further comprising a pushing component associated with said at least one separation gate, the pushing component adapted to impact an item being sorted when said item contacts the at least one separating gate, thereby directing the item being sorted to a desired location.

10. A method of sorting items according to at least one predetermined criterion, the method of comprising the steps of:
a) providing at least one item along a conveyor, the conveyor directing the item to a measuring unit;
b) measuring the at least one item with the measuring unit;
c) determining based on the measurement in step b) at least one characteristic of the item;
d) actuating selectively a gate based on the at least one characteristic determined in step c);
e) directing the at least one item to a conveyor associated with the gates actuated in step d) such that the gate directs the at least one item to a desired location based on the at least one characteristic.

11. The method according to claim 10 wherein the at least one characteristic of the item is size.

12. The method according to claim 10 wherein the at least once characteristic is weight.

13. The method according to claim 10 wherein the measuring unit is a scale.

14. The method according to claim 10 wherein the measuring unit is an imaging device.

15. A device for sorting items according to at least one predetermined criterion, the device comprising:
at least one conveyor for transporting an item along at least a portion of the device, the conveyor adapted to receive said item oriented such that a long axis of said item is substantially perpendicular to the direction of movement of the conveyor;
a measuring unit positioned in proximity to the conveyor such that the conveyor moves the item into position to be measured by said measuring unit;
at least one separation gate capable of moving between a first position away from said conveyor and a second position along a length of said conveyor; and
a pushing component associated with said at least one separation gate, the pushing component adapted to impact an item being sorted when said item contacts the at least one separation gate, thereby directing the item being sorted to a desired location,
wherein the at least one separation gate is actuated to move from said first position to said second positioned based on a predetermined criterion of the item being sorted.

16. The device according to claim 15, wherein the at least one separation gate moves from the first position to the second position by a rotating action.
